(19) United States
(12) Patent Application Publication
(10) Pub. No.: US 2015/0348051 A1
(43) Pub. Date: Dec. 3, 2015

(54) Providing Recommendations Through Predictive Analytics

(71) Applicants: Gabriele Bodda, Palo Alto, CA (US); Ryan Currier, Palo Alto, CA (US); Venkitesh Subramanian, Palo Alto, CA (US); Prerna Makanawala, Mountain View, CA (US); Rei Kasai, Palo Alto, CA (US); Devasena Rajamohan, Palo Alto, CA (US); Amith Manoharan Chithambaram, Palo Alto, CA (US); Terence Chesire, Palo Alto, CA (US); Kiran Karadi, Palo Alto, CA (US)

(72) Inventors: Gabriele Bodda, Palo Alto, CA (US); Ryan Currier, Palo Alto, CA (US); Venkitesh Subramanian, Palo Alto, CA (US); Prerna Makanawala, Mountain View, CA (US); Rei Kasai, Palo Alto, CA (US); Devasena Rajamohan, Palo Alto, CA (US); Amith Manoharan Chithambaram, Palo Alto, CA (US); Terence Chesire, Palo Alto, CA (US); Kiran Karadi, Palo Alto, CA (US)

(21) Appl. No.: 14/447,923

(22) Filed: Jul. 31, 2014

Related U.S. Application Data
(60) Provisional application No. 62/006,776, filed on Jun. 2, 2014.

(51) Int. Cl. G06Q 30/00; G06F 17/30

(52) U.S. Cl. CPC G06Q 30/016; G06F 17/3053

(57) ABSTRACT

A recommendation engine analyzes metrics on an active support ticket to provide recommended solutions, technicians and offers. The recommendation can communicate with a predictive analysis engine to identify solutions, technicians, or offers that are highly correlated with the input parameters. In some embodiments, instructions can be provided to a client device for measuring a metric that is used as an input parameter of the predictive analysis engine. The customer or the technician can follow the instructions to measure the metric.

### BACKGROUND

Business entities that offer products or services often need to provide support to customers for issues that arise from use of the products or services. These issues can be tracked using an issue tracking system. An issue tracking system is a computer software package configured to manage and maintain reported issues with the products or services. A manager typically uses a manager dashboard to monitor and track the progress of these tickets.

For any given issue, a customer support representative (or technician) needs to analyze the problem that the customer is experiencing to determine the cause of the problem. Once the cause has been determined, the customer support representative then needs to identify solutions that may be able to resolve the problem. Each solution can be applied until the problem is resolved. This process can be very time consuming, particularly for complex products that have many different components. Problems can arise in each component or the interoperability of multiple components.

As businesses grow, the number of products and services that are offered by the company also grow. The increase in the number of products can make it rather difficult for the customer support representative to diagnose and resolve all the problems since each product can be different and require intimate knowledge of the product. Moreover, growing businesses generally have more customers, which means more support tickets for the customer support representative to handle. Supporting these growing businesses can be very daunting.

### SUMMARY

In one embodiment, a computer-implemented method receives, from a client device, an issue report configured to report a problem experienced with a sales item. The method then identifies, by a processor, a metric associated with the sales item that is missing in the issue report. The method then transmits, by the processor, a measurement request to the client device to retrieve the metric. The method then continues by receiving, by the processor, the metric from the client device. The method then performs, by the processor, a query on a predictive analysis engine to generate a ranked list of solutions that are applicable to the issue, the query including the metric. After performing the query, the method can select, by the processor, a recommended solution from the ranked list. Finally, the method transmits, by the processor, the recommended solution to the client device.

In one example, the identifying the metric includes identifying the metric comprises identifying a plurality of metrics utilized by the predictive algorithm to generate the ranked list and determining that the metric is missing in the issue report. In another example, the measurement request includes at least one user instruction to retrieve the metric using the client device. The metric can be measured using a sensor on the client device. In another example, the recommended solution is an on-site visit from a technician. The method can continue by transmitting, by the processor, another measurement request to another client device, the another client device being operated by the technician, receiving, by the processor, another metric from the another client device, and performing, by the processor, another query on the predictive analysis engine to generate another ranked list of solutions that are applicable to the issue, the query including the metric and the another metric; selecting, by the processor, another recommended solution from the another ranked list, and transmitting, by the processor, the another recommended solution to the another client device. In another example, the method can perform, by the processor, another query on the predictive analysis engine to generate another ranked list of technicians available to service the problem, select, by the processor, a technician from the another ranked list, and schedule, by the processor, the technician to the on-site visit.

In another embodiment, a non-transitory computer readable storage medium receiving, from a client device, an issue report configured to report a problem experienced with a sales item, identifying a metric associated with the sales item that is missing in the issue report, transmitting a measurement request to the client device to retrieve the metric, receiving the metric from the client device, performing a query on a predictive analysis engine to generate a ranked list of solutions that are applicable to the issue, the query including the metric selecting a recommended solution from the ranked list, and transmitting the recommended solution to the client device.

In yet another embodiment, a computer implemented system comprises one or more computer processors and a non-transitory computer-readable storage medium. The non-transitory computer-readable storage medium comprises instructions, that when executed, control the one or more computer processors to be configured for receiving, from a client device, an issue report configured to report a problem experienced with a sales item, identifying a metric associated with the sales item that is missing in the issue report, transmitting a measurement request to the client device to retrieve the metric, receiving the metric from the client device, performing a query on a predictive analysis engine to generate a ranked list of solutions that are applicable to the issue, the query including the metric selecting a recommended solution from the ranked list, and transmitting the recommended solution to the client device.

The following detailed description and accompanying drawings provide a better understanding of the nature and advantages of the present disclosure.

### BRIEF DESCRIPTION OF THE DRAWINGS

FIG. 1 illustrates a high level system according to one embodiment;

FIG. 2 illustrates a system according to one embodiment;

FIG. 3 illustrates an exemplary support ticket according to one embodiment;

FIG. 4 illustrates an exemplary support ticket lifecycle according to one embodiment;

FIG. 5A depicts a workflow for recommending a solution to an active support ticket according to one embodiment;

FIG. 5B depicts another workflow for recommending a solution to an active support ticket according to one embodiment;

FIG. 6 depicts a workflow for recommending a technician to be assigned an active support ticket according to one embodiment;

FIG. 7 depicts a workflow for recommending a best offer to an active support ticket according to one embodiment; and

FIG. 8 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

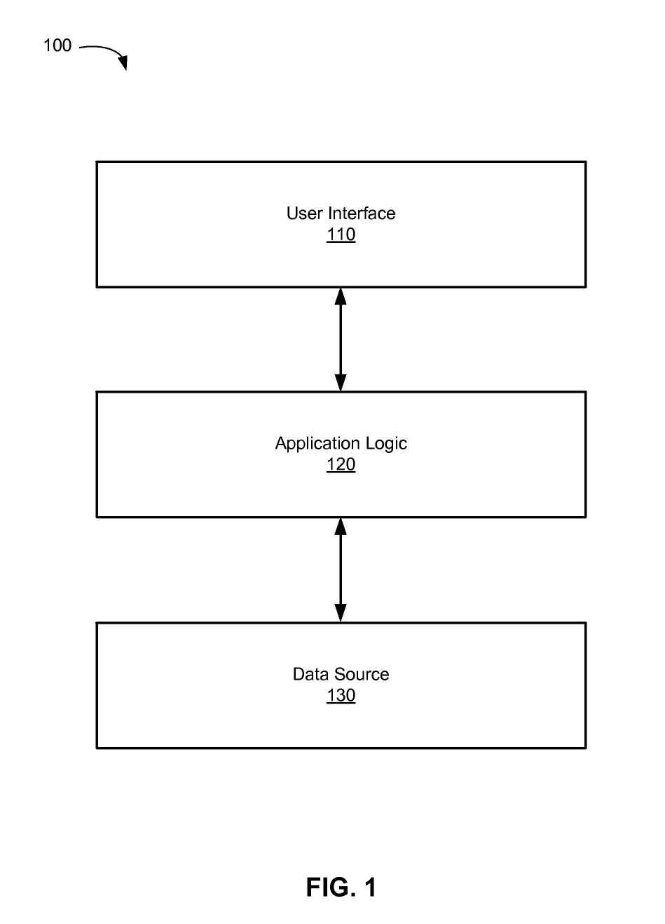

FIG. 1 illustrates a high level system 100 according to one embodiment. System 100 is an application implemented in computer code that can be executed on the server side, the client side, or a combination of both. In one embodiment, system 100 is executed using a plurality of computers communicating with one another via the Internet to provide an issue tracking system capable of providing recommendations. Each active support ticket can describe an unresolved issue that a customer or employee is having with a sales item offered by the business entity. A sales item can be a product or service that is placed on sale or available for license. For example, a product for sale can be a pharmaceutical drug, a laundry machine, or a computing device, a service for sale can be housekeeping services, and a product for license can be a software license for a software application. The support ticket can remain in an active state until the issue has been resolved or until the issue is no longer being handled by customer support. At this point, the state of the support ticket can change from active to completed.

System 100 includes user interface layer 110, application logic layer 120, and data source layer 130. Each layer can reside on the server side, client side, or both the server side and client side. For example, user interface layer 110 can be implemented on the client device while application logic layer 120 and data source layer 130 are implemented on the server side. Data source layer 130 includes a variety of data sources containing data that is analyzed by sales tools stored in application logic layer 120. In one example, data source layer 130 includes data about a company. This can include active support tickets, completed support tickets, information about the sales force of the company, information about the sales items that the company offers for sale, and information about customers of the company. In other examples, other types of data related to the company, competing companies, sales items, and customers can be stored in data source layer 130. For instance, news related to sales items (e.g., recalls, updates to FDA approval, etc.) and customers (e.g., upcoming IPOs, lawsuits, etc.) can also be a part of data source 130. In some embodiments, the data sources that make up data source layer 130 can be stored both locally and remotely. For example, support tickets which are sensitive to the company can be stored and managed in local databases that belong to the company while non-sensitive company information can be periodically retrieved from a remote source.

Application logic layer 120 is coupled to data source layer 130. Application logic layer 120 includes one or more sales tools that can analyze the collective knowledge available from data source layer 130 to predict the outcome of a support ticket. In another embodiment, a sales tool can utilize a predictive analysis engine to provide recommendations. The recommendations can include recommending a solution for a problem, recommending a technician to visit a customer to perform on-site service, and recommending an offer that can be presented while interacting with the customer.

User interface layer 110 is coupled to application logic layer 120. User interface layer 110 can receive user input for controlling a sales tool in application logic layer 120. User interface layer 110 can interpret the user input into one or more instructions or commands which are transmitted to application logic layer 120. Application logic layer 120 processes the instructions and transmits the results generated from application logic layer 120 back to user interface layer 110. User interface layer 110 receives the results and presents the results visually, audibly, or both. In one embodiment, user interface layer 110 can present a landing page containing information related to recommended solutions for an active support ticket, recommended offers to present to a customer while resolving an active support ticket, and recommended technicians to assign to an active support ticket. The status of the active support tickets can be monitored. Optionally, tasks can be performed on the support tickets from the landing page such as assigning solutions, technicians, and offers to an active support ticket.

As the support ticket goes through the different phases of a support ticket lifecycle, application logic layer 120 can provide different recommendations to a support ticket based on results provided by predictive analysis engine 240. This is due to the fact that attributes of the support ticket can change throughout the lifecycle of the support ticket and that the data available for analysis is ever increasing with the passage of time. In some embodiments, system 100 can periodically recommend solutions, offers, or other recommendations to one or more support tickets. For example, recommended solutions can be periodically provided as new data is collected and analyzed.

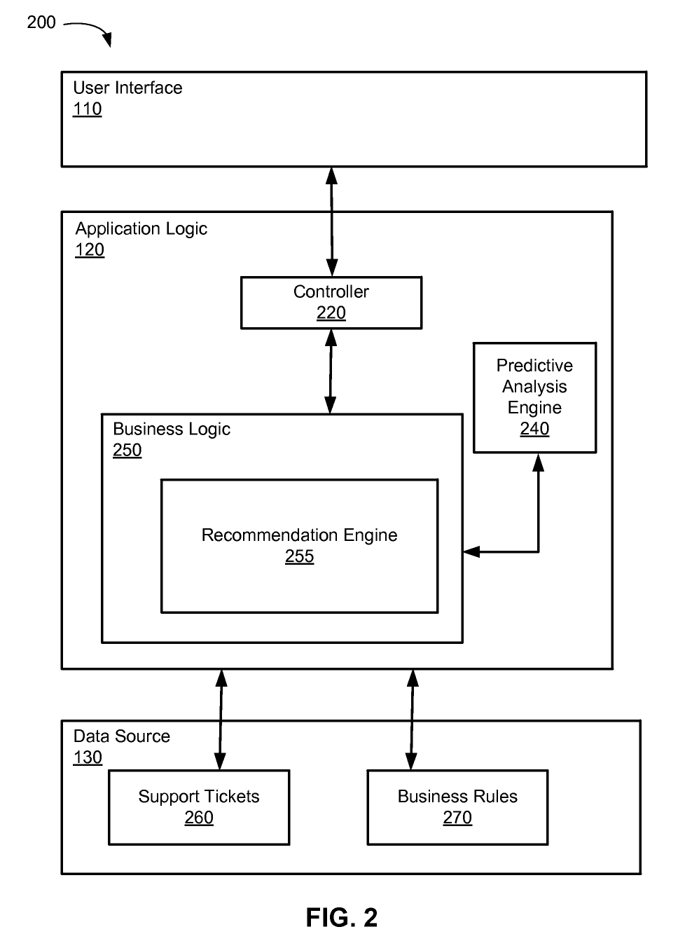

FIG. 2 illustrates a system 200 according to one embodiment. System 200 is an application implemented in computer code that can be executed on the server side, the client side, or both. For example, user interface 110 can be executed on the client while application logic 120 and data source 130 can be executed on one or more servers. The client can be an electronic device that is used by the customer to receive assistance from the business entity. Alternatively, the client can be an electronic device that is used by a manager of the business entity to manage active support tickets. Application logic 120 includes controller 220, predictive analysis engine 240, and business logic 250. Controller 220 is configured to control the operations of system 200. Controller 220 receives user input from user interface 110 and translates the user input into a command which is communicated to business logic 250. A procedure from business logic 250 that corresponds with the command can be called by controller 220 to process the command. In one embodiment, a command can call upon recommendation engine 255 of business logic 250.

Recommendation engine 255 can communicate with data source 130 to provide recommendations that are used when handling an active support ticket. The recommendations can range from a recommended solution to resolve the active support ticket, a recommended offer to present while resolving the active support ticket, or a recommended technician to assign to an active support ticket. Each active support ticket can represent a problem with a sales item offered by the business entity. The active support ticket can be generated by an employee or a customer of the business entity.

Recommendation engine 255 can transmit queries to predictive analysis engine 240. Predictive analysis engine 240 can in turn process the queries to generate results that have high correlation to the contents provided in the query. The results can be generated from evaluating support tickets 260 of data source 130, which can include active support tickets and completed support tickets. In other examples, other databases within data source 130 can be accessed by predictive analysis engine 240. The contents of the query can depend on the configuration of recommendation engine 255 or the type of recommendation desired (e.g., a solution, offer, or technician). In one embodiment, recommendation engine 255 can provide a query that includes the symptoms of the active support ticket and diagnostic information collected on an active support ticket and request a ranked list of solutions that are highly correlated with the symptoms and diagnostic information provided. In another embodiment, recommendation engine 255 can provide a query that includes customer metadata, symptoms of the active ticket, and/or diagnostic information collected on the active support ticket to request a ranked list of offers or technicians that are highly correlated with the information provided. In one embodiment, recommendation engine 255 can be configured by using a rule from business rules 270 to recommendation a solution, offer, or technician. In other embodiments, business logic 250 can include multiple recommendation engines where a first provides a recommended solution, a second provides a recommended offer, and a third provides a recommended technician.

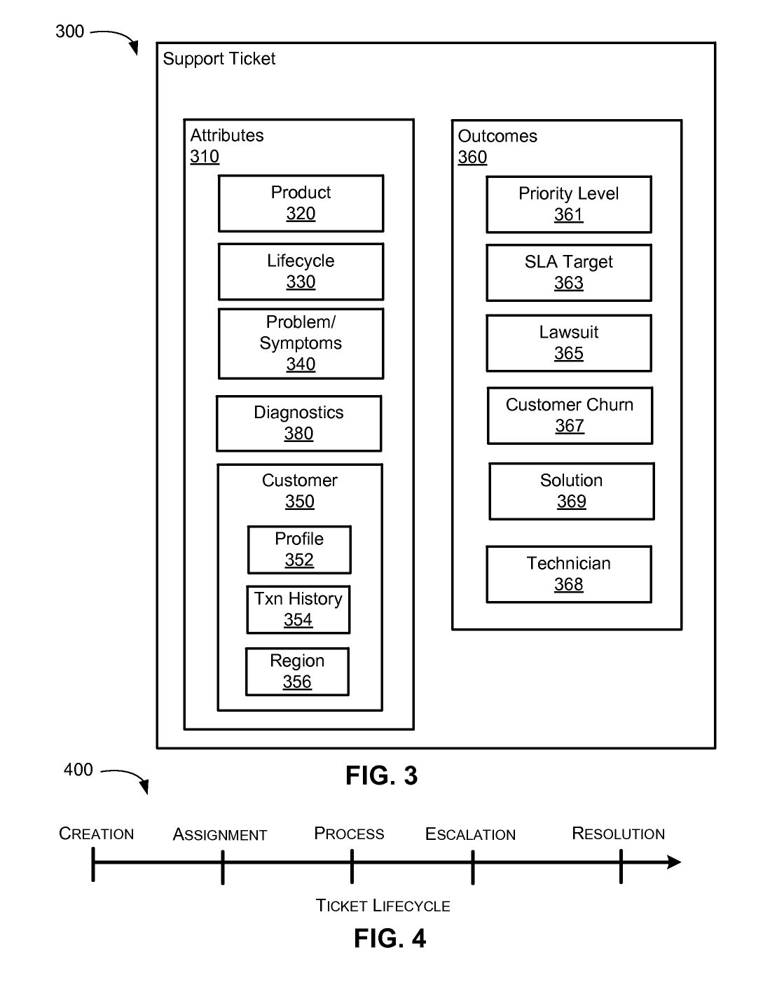

FIG. 3 illustrates an exemplary support ticket according to one embodiment. Support ticket 300 includes attributes 310 and outcomes 360. Attributes 310 can store information relevant to the problem that support ticket is trying to resolve. In some embodiments, support ticket 300 can include one or more of attributes including product 320 which contains details about the sales item that the support ticket is being created for, lifecycle 330 which contains details about the lifecycle of the support ticket, problem 340 which contains details describing the problem that the support ticket is attempting to address, diagnostics 380 that have been captured during the lifecycle of the support ticket, and customer 350 which contains details on the customer (or employee) that created the support ticket.

In one embodiment, product 320 can include an identifier for the sales item that is seeking support. Each sales item associated with the business entity can have a corresponding identifier that is used to distinguish the sales item from other sales items. The identifier can be unique for each type of sales item (e.g., all dishwashers that are the same model have the same unique identifier) or can be unique for each sales item (e.g., all dishwashers that are the same model have a different unique identifier).

In one embodiment, lifecycle 330 can store information related to the lifecycle of support ticket 300. This can include tracking the date and time information associated with different stages of the lifecycle of support ticket 300. For example, the date and time that the support ticket enters or exits each stage of the support ticket lifecycle can be stored and tracked in lifecycle 330. In other examples, details on each stage of the support ticket lifecycle can also be stored and tracked in lifecycle 330.

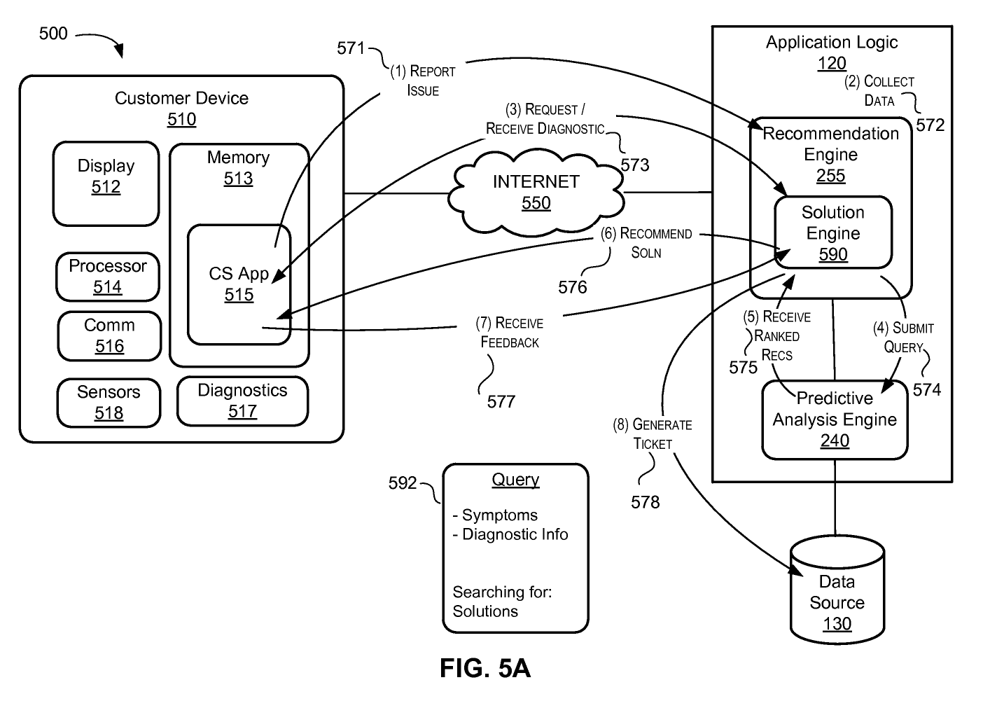

FIG. 4 illustrates an exemplary support ticket lifecycle according to one embodiment. Ticket lifecycle 400 begins with the creation stage where the support ticket is generated. The support ticket can be generated by a system such as system 200 of FIG. 2 or a third party system in response to a customer request. After the support ticket is created, ticket lifecycle 400 can continue to the assignment stage where the support ticket is assigned to one or more parties who are responsible for resolving issues or problems that are described within the support ticket. The responsible parties can change during the lifecycle of the support ticket. For example, a first technician can be at first assigned to the support ticket. At a later point in time, a second technician can take ownership of the support ticket from the first technician. After the support ticket is assigned, ticket lifecycle 400 can continue to the process stage where the party or parties assigned to the support ticket can process the support ticket. Processing can include applying one or more solutions to the sales item to try and solve the issues or problems described in the support ticket. Processing can also include capturing diagnostic information. For example, the customer or a technician can use a device to capture diagnostic information on the sales item. Exemplary diagnostic information can include the temperature, the voltage, the current, or the processing power of the sale item. Processing can also include assigning a technician to visit the customer to help solve the problem. As the support ticket is processed, the assigned party can update the status of the support ticket. In some examples, ticket lifecycle 400 can continue to a stage during processing where the support ticket is escalated. Escalation of the support ticket can occur when the customer creating the support ticket is unhappy with how the support ticket is being handled by the assigned party and escalates the support ticket. The escalation stage can include changing one or more properties of the support ticket. For example, a status attribute of a support ticket can be upgraded from one priority to another, selected from the set of low priority, normal priority, and high priority. After the processing stage, ticket lifecycle 400 can enter the resolution stage. In the resolution stage, the issues or problems within the support ticket have been addressed to the satisfaction of the customer. At this time, the support ticket can change state from active to completed.

Returning to FIG. 3, attributes 310 can include problem/symptoms 340. Problem/symptoms 340 includes details on the problem, symptom, or issue which the support ticket is attempting to address. For example, problem 340 can include one or more fields that store the type of problem (e.g., warranty issue, customer service call, repair, recall, etc.), a description of the problem, symptoms that the sales item is experiencing, or solutions that have been attempted by the customer

Attributes 310 can also include customer 350. Customer 350 stores customer information which can include profile 352, transaction history 354, and region 356. Profile 352 can store a profile of customer 350. The profile can include the customer's name, address, billing information, service coverage, licensing information, and others. Transaction history 354 can store the transaction history of support tickets that customer 350 has created. This can include a summary of the support tickets that the customer has opened and completed plus the outcomes that resulted from the completed support tickets. Region 356 can identify the geological region which the customer resides in. The geological region can be useful in determining whether a geological region experiences more support tickets than other regions.

Besides attributes 310, support ticket 300 further includes outcomes 360. As a support ticket is processed, certain outcomes can result from the processing. For example, processing the support ticket can escalate the support ticket to a higher priority, result in a customer taking his or her business away from the business entity (i.e., customer churn), or even worse can result in a lawsuit filed against the business entity. Outcomes 360 can describe the outcomes that resulted from processing support ticket 300. As support ticket 300 is processed by a technician or a customer support representative, outcomes 360 can change throughout the lifecycle of support ticket 300. In some embodiments, outcome 360 can include priority level 361 which describes the importance of support ticket 300. When support ticket is escalated by a customer due to a customer calling in to complain or speaking with a supervisor, the system can escalate priority level 361. Support tickets which have an escalated priority level when the support ticket has reached resolution can be considered support tickets that were troublesome.

Outcomes 360 can further include SLA target flag 363. SLA target flag 363 can define whether then problem associated with support ticket 300 was solved within the period of time defined in the customer's service agreement with the business entity. Some customer's may have an agreement with the business entity that all support tickets will be resolved within a week of creating the support ticket while other customers who have a better service agreement with the business entity may have an agreement with the business entity that all support tickets will be resolved within 72 hours of creating the support ticket. A support ticket where the problem was resolved before missing the SLA target can have a SLA target flag 363 set to false while a support ticket where the problem was not resolved before missing the SLA target can have SLA flag 363 set to true, or vice versa.

Outcomes 360 further include lawsuit 365. Lawsuit 365 can be a field configured to store information related to lawsuits that have been filed against the business entity as a result of processing support ticket 300. Outcomes 360 can further include customer chum 367. Customer chum 367 can store information related to whether business from the customer has declined as a result of how the business entity has handled support ticket 300. For example customer chum 367 can track whether the customer has reduced business with the business entity or whether the customer is no longer a customer of the business entity. Outcomes 360 can further include solution 369. Solution 369 can describe the solution that was used in resolving support ticket 300. Some support tickets can be closed after a period of time where the support ticket has not been solved. In this scenario, solution 369 can be blank or be populated with the solutions that were tried but unsuccessful. Outcomes 360 can also include technician field 368 that identifies the technicians (or customer support representatives) that assisted in the active support ticket.

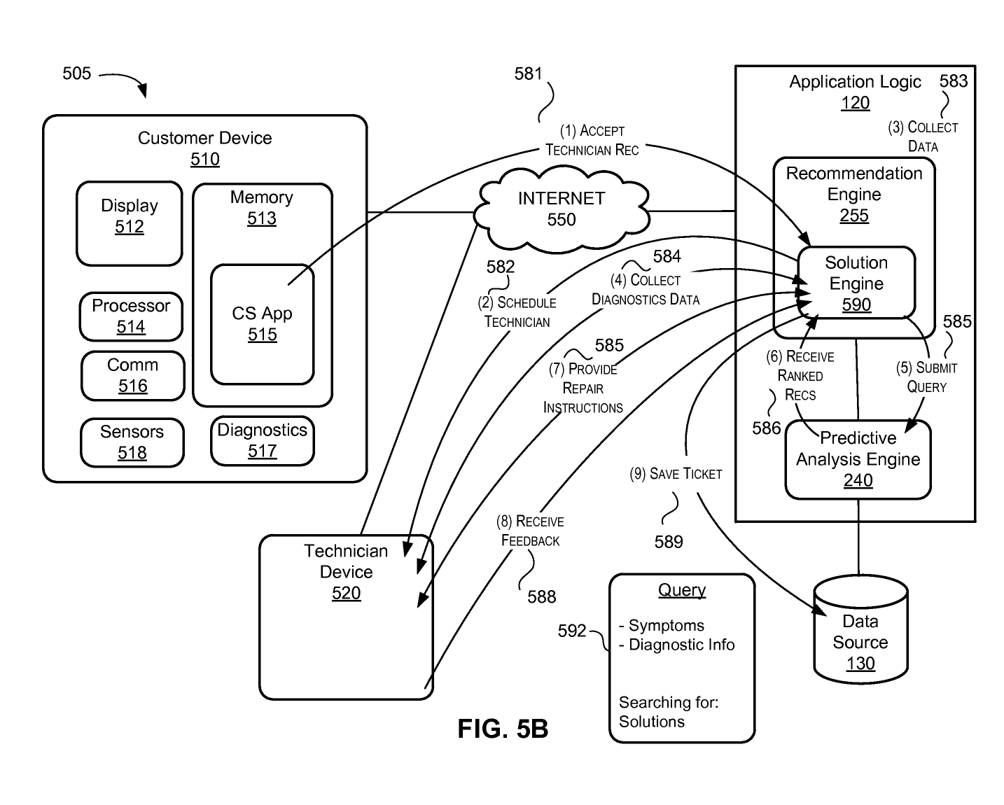

FIGS. 5-7 below describe a variety of uses cases for recommendation engine 255. Each use case describes a scenario in which recommendation engine 255 can provide recommendations that may be useful during the lifecycle of an active support ticket. Exemplary scenarios can include recommending a solution to an active support ticket, recommending a technician (or other employee of the business entity such as a customer support representative) be assigned to an active support ticket, or recommending offers that may be of interest to a customer of an active support ticket.

FIG. 5A depicts a workflow for recommending a solution to an active support ticket according to one embodiment. Workflow 500 includes customer device 510, application logic 120, and data source 130. Application logic 120 includes recommendation engine 255, which includes solution engine 590. Alternatively, recommendation engine 255 can be configured as solution engine 590. Application logic 120 further includes predictive analysis engine 240. Customer device 510, application logic 120, and data source 130 can communicate with one another through internet 550.

Customer device 510 can be an electronic device that includes display 512 and processor 514. Processor 514 can execute customer service application 515 of memory 513 and present a graphical user interface (GUI) on display 512. Customer service application 515 can be configured to allow a customer to report issues with a sales item which the business entity is responsible for supporting. By providing customer service application 515 on customer device 510, a customer is able to troubleshoot problems on his own. This can result in a better customer experience for customers that do not like to wait on a technician. This can also reduce the workload of technicians since customers are attempting to resolve issues with the sale item themselves. In some examples, customer device 510 can be a portable electronic device, such as a smart phone, a tablet, or a notebook computer.

Workflow 500 begins with customer service application 515 reporting an issue with a sales item at step (1) (reference numeral 571). In one example, this can be in response to the customer experiencing an issue with the sales item. The reported issue is transmitted from customer device 510 to recommendation engine 255. In some embodiments, the report can include metadata describing the issue that the customer is experiencing. For example, the report can include metadata stating a short description provided by the customer describing the problem, a customer ID to identify the customer, and the type of sales item that is experiencing the problem. In the request, the consumer can specify that he would like to have a solution recommended. Workflow 500 continues with solutions engine 590 collecting data on the problem at step (2) (reference numeral 572). The data collected can depend on the type of problem that the customer is experiencing or the sales item which the customer is having an issue with. In one embodiment, solution engine 590 can collect data that is later used by predictive analysis engine 240 to provide recommended solutions.

In some embodiments, solution engine 590 can request diagnostic data from the sales item to help diagnose the problem and find a solution. Given that the sales item is located in the vicinity of the customer, solution engine 590 can communicate with customer device 510 to collect the diagnostic information. In some examples, functionality present on customer device 510 can be utilized to collect the diagnostic information. For example, communication 516 can be used to communicate with the sales item to retrieve attributes or properties of the sales item. For instance, a crash report, a core dump, or a status log can be downloaded from the sales item through communication 516. As another examples, sensors 518 or diagnostic tools 517 of customer device 510 can be utilized to collect measurements from the sales item. For instance if the sales item is a washing machine, placing the consumer device 510 on the washing machine allows sensor 518 of customer device 510 to collect vibration patterns from the washing machine. This can be useful when trying to troubleshoot the washing machine. As shown here, solution engine 590 can request and receive diagnostic information from customer device 510 at step (3) (reference numeral 573). In one example, solution engine 590 can transmit instructions to customer service application 515. Customer service application 515 can process the instructions and issue instructions to communication 516, sensors 518, diagnostics 517 or display 512. The customer can follow instructions provided on display 512 to help solutions engine 590 retrieve the diagnostic information it needs to recommend a solution.

Once solution engine 590 has collected sufficient data to identify recommended solutions, solution engine 590 can submit query 592 to predictive analysis engine 240 at step (4) (reference numeral 574). Query 592 can include details of the active support ticket such as symptoms and diagnostic information. Query 592 can also specify what solutions engine 590 would like predictive analysis engine 240 to predict, which is recommended solutions. Predictive analysis engine 240 can process the contents of the query to identify completed support tickets having a high correlation score with the content provided in the query and then rank the solutions that were utilized in the identified completed support tickets. Workflow 500 then continues with solution engine 590 receiving the ranked list of recommended solutions from predictive analysis engine 240 at step (5) (reference numeral 575). Solutions engine 590 analyzes the ranked list and transmits a recommended solution to customer service application 515 at step (6) (reference numeral 576). In one example, the recommended solution is the highest ranked solution that has not been attempted already by the customer.

The customer can attempt the recommended solution and provide feedback on the quality of the recommended solution to solution engine 590 at step (7) (reference numeral 577). If the recommended solution resolved the problem, customer device 510 can transmit a success message to solution engine 590. If the recommended solution did not resolve the problem, customer device 510 can transmit a failure message to solution engine 590. In one embodiment, the failure message can result in solution engine 590 providing another recommended solution in the ranked list to customer device 510. In another embodiment, the failure message can result in solution engine 590 collecting additional data from the sale item. The additional data can be combined with the previously collected data and submitted to predictive analysis engine 240 to generate another ranked list of recommended solutions. With the additional data, the new ranked list of recommended solutions can be different than the previously generated ranked list of recommended solutions. At some time between reporting the issue and receiving feedback on the recommended solution, solution engine 590 can generate a support ticket for the reported issue and store the support ticket in data source 130. Through the different stages of the support ticket's lifecycle, solution engine 590 can update the contents of the support ticket.

In some embodiments, solution engine 590 may recommend a technician visit to customer device 510 as the recommended solution. A technician visit is where a technician employed by the business entity visits the customer to resolve the problem with the sales item in person. FIG. 5B depicts another workflow for recommending a solution to an active support ticket according to one embodiment. Here, solution engine 590 is recommending a solution to technician device 520 rather than customer device 510 since the technician is troubleshooting the problem in person. FIG. 5B can be a continuation from FIG. 5A when a technician visit is the recommended solution.

Workflow 505 beings with customer service application 515 accepting the recommended solution of having a technician visit the customer at step (1) (reference numeral 581). Accepting the technician recommendation can include providing times which the customer will be available for a technician's visit. Solution engine 590 can schedule a technician to visit the customer at step (2) (reference numeral 582). When the technician visits the customer at the scheduled time, solution engine 590 can collect additional data used to provide a recommended solution at step (3) (reference numeral 583). Solution engine 590 can provide instructions to technician device 520 to collect diagnostics data at step (4) (reference numeral 584). For example, solution engine 590 can transmit instructions to technician device 520. The technician can follow the instructions transmitted to collect the additional data that is used by predictive analysis engine 240 to recommend solutions. In one example, technician device 520 may have additional functionality over what is available on customer device 510 that allows technician device 520 to collect more data or more accurate data.

Once the data has been collected, workflow 505 can continue with solution engine 590 submitting query 592 to predictive analysis engine 240 at step (5) (reference number 585). The additional content can be used to identify solutions that are highly correlated to the collected data. Solution engine 590 can receive the ranked recommendations at step (6) (reference numeral 586). A solution from the ranked list that has not yet been tried can be transmitted to technician device 520 as repair instructions which the technician performs. In one example, the highest ranked solution which has not yet been attempted can be transmitted to technician device 520. Once the repair instructions have been completed, the technician can utilize technician device 520 to respond with feedback on the solution at step (8) (reference numeral 588). Solution engine 590 can update the active support ticket stored in data source 130 based on the results of the on-site repair at step (9) (reference numeral 589).

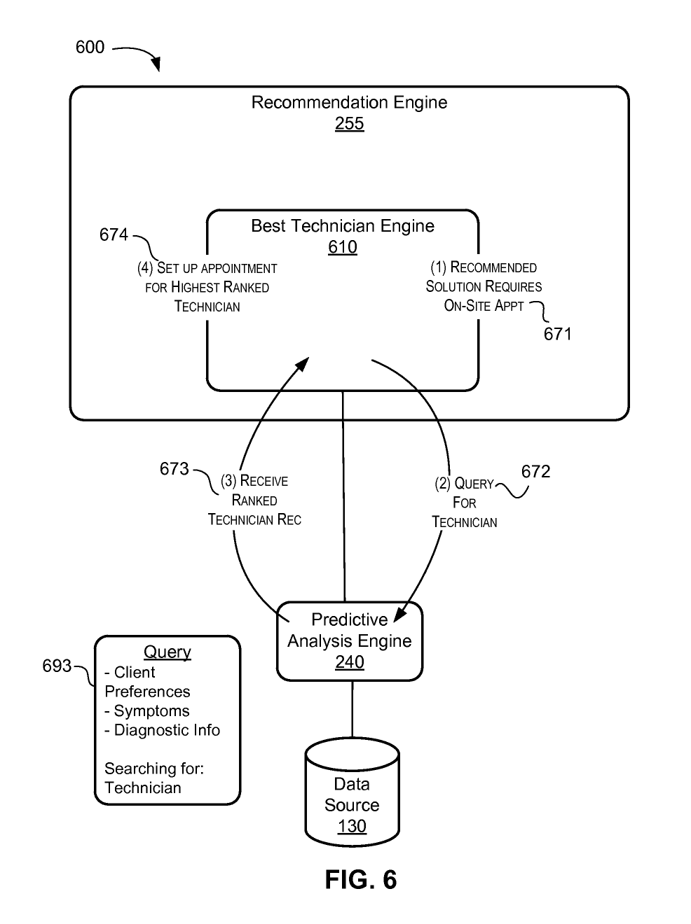

As described above, solution engine 590 can periodically recommend a technician visit. A typical business entity will have many technicians who can be assigned to a particular active support ticket. FIG. 6 depicts a workflow for recommending a technician to be assigned an active support ticket according to one embodiment. Workflow 600 can be performed to recommend a technician to a customer who is going through an automated process to schedule a technician visit or can be performed to recommend a technician to a manager who is monitoring active support tickets. The manager or the customer can utilize workflow 600 to receive recommendations on technicians. Workflow 600 includes recommendation engine 255, which includes best technician engine 610. Alternatively, recommendation engine 255 can be configured as best technician engine 610. Best technician engine 610 is configured to recommend a technician to service an active support ticket.

Workflow 600 can begin with recommendation engine 255 recommending an on-site appointment at step (1) (reference numeral 671). Best technician engine 610 can submit query 693 to predictive analysis engine 240 for a technician at step (2) (reference numeral 672). In some embodiments, query 693 can be different than query 592 of FIG. 5A. Query 693 is configured for a technician recommendation and thus contains different content and requests a different outcome. Here, query 693 includes client preferences, symptoms, diagnostic info, and a request to return a ranked list of technicians. The client preferences can help avoid a technician being assigned to a customer who previously had a bad experience with the technician. After providing the query, best technician engine can receive a ranked list of technician recommendations at step (3) (reference numeral 673). Workflow 600 can then continue by setting up an appointment with the highest ranked technician that is available during the time slot suggested by the customer at step (4) (reference numeral 674).

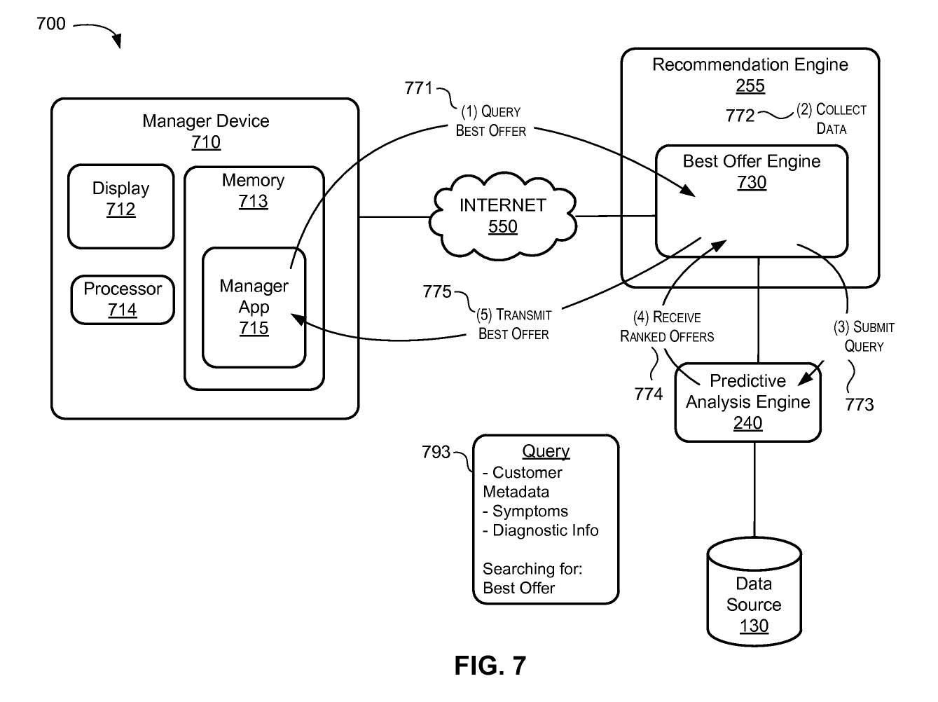

FIG. 7 depicts a workflow for recommending a best offer to an active support ticket according to one embodiment. Workflow 700 includes manager device 710, recommendation engine 255, predictive analysis engine 240, and data source 130. Recommendation engine 255 includes best offer engine 730. Alternatively, recommendation engine 255 can be configured as best offer engine 730. Customer device 510, recommendation engine 255, best offer engine 730, predictive analysis engine 240, and data source 130 can communicate with one another through internet 550. While workflow 700 is described below as a technique for providing best offer recommendations to a manager, a similar technique can be utilized to provide best offer recommendations to a customer. For example, a best offer can be automatically determined and presented to a customer to see whether the customer would like to accept the offer. In these examples, manager device 710 can be replaced with customer device 510 of FIG. 5A.

Manager device 710 can be an electronic device that includes display 712 and processor 714. Processor 714 can execute manager application 715 of memory 713 and present a graphical user interface (GUI) on display 712. Manager application 715 can be configured to allow a manager to monitor active and completed support tickets of the business entity which the manager is responsible for. This can include the selection of which offers to present to customers.

Workflow 700 begins with manager application 715 querying best offer engine 730 for a best offer at step (1) (reference numeral 771). The query can be an automated query that is transmitted at a predefined interval or a request submitted by a manager. Workflow 700 continues with best offer engine 730 collecting data on the problem at step (2) (reference numeral 772). The data collected can be related to the customer or the active support ticket. In one embodiment, previously collected data (e.g., data collected by the customer or by a technician) can be packaged to form the query. Query 793 is an exemplary query which contains customer metadata such as previous offers accepted/declined, the demographic of the customer, customer's likes and dislikes, and others. The customer metadata can be useful so that customers with similar likes and dislikes can be provided the same offer, particularly if the other customer had accepted the offer. Query 793 can also include symptoms or diagnostic information that is associated with the active support ticket. The symptoms and diagnostic information can be useful so that customers experiencing the same issue can be provided the same offer. For example, customers that are experiencing a broken dishwasher can be offered a five year warranty on the dishwasher.

Once the query is created, best offer engine 730 can submit a query to predictive analysis engine 240 at step (3) (reference numeral 773). Predictive analysis engine 240 can evaluate the query to generate a ranked list of best offers by correlating the content provided in the query with known information in data source 130. Best offer engine 730 can then receive the ranked offers from predictive analysis engine 240 at step (4) (reference numeral 774). Best offer engine 730 in turn selects an offer from the ranked list and transmits the best offer to manager application 715 at step (5) (reference numeral 775).

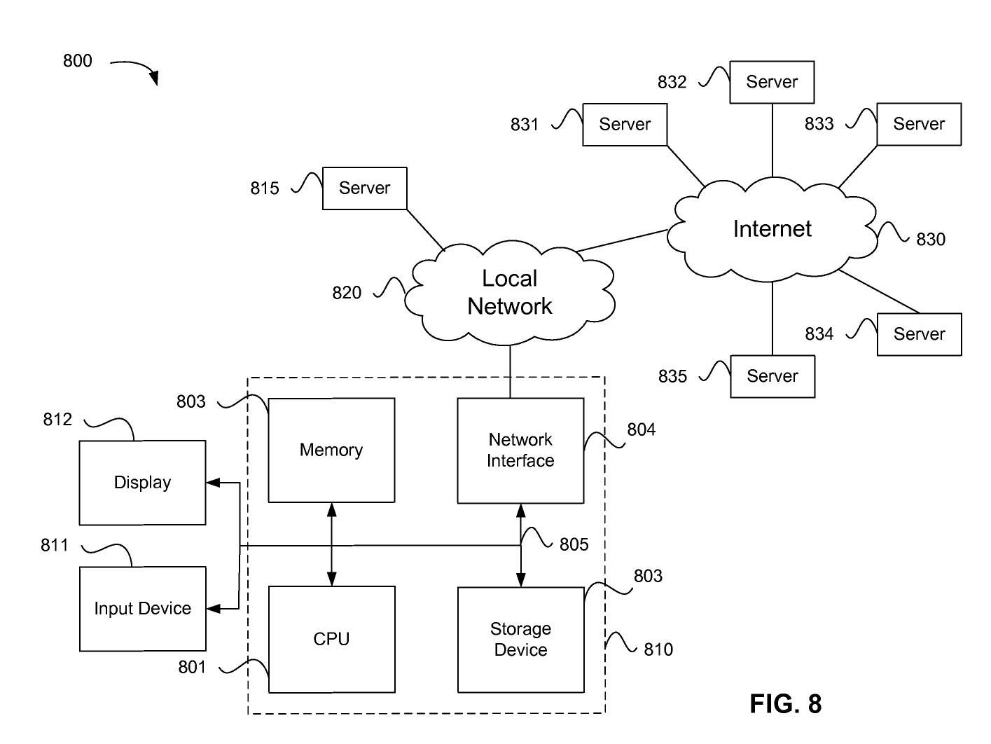

An exemplary computer system 800 is illustrated in FIG. 8. Computer system 810 includes bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable mediums.

Computer system 810 may be coupled via bus 805 to a display 812, such as a cathode ray tube (CRT) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information, including messages or other interface actions, through the network interface 804 across a local network 820, an Intranet, or the Internet 830. For a local network, computer system 810 may communicate with a plurality of other computer machines, such as server 815. Accordingly, computer system 810 and server computer systems represented by server 815 may form a cloud computing network, which may be programmed with processes described herein. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, from a client device, an issue report configured to report a problem experienced with a sales item;
identifying, by a processor, a metric associated with the sales item that is missing in the issue report;
transmitting, by the processor, a measurement request to the client device to retrieve the metric;
receiving, by the processor, the metric from the client device;
performing, by the processor, a query on a predictive analysis engine to generate a ranked list of solutions that are applicable to the issue, the query including the metric;
selecting, by the processor, a recommended solution from the ranked list; and
transmitting, by the processor, the recommended solution to the client device.

2. The computer-implemented method of claim 1, wherein identifying the metric comprises:
identifying, by the processor, a plurality of metrics utilized by the predictive algorithm to generate the ranked list; and
determining, by the processor, that the metric is missing in the issue report.

3. The computer-implemented method of claim 1, wherein the measurement request includes at least one user instruction to retrieve the metric using the client device.

4. The computer-implemented method of claim 3, wherein the metric is measured using a sensor on the client device.

5. The computer-implemented method of claim 1, wherein the recommended solution is an on-site visit from a technician.

6. The computer-implemented method of claim 5, further comprising:
transmitting, by the processor, another measurement request to another client device, the another client device being operated by the technician;
receiving, by the processor, another metric from the another client device;
performing, by the processor, another query on the predictive analysis engine to generate another ranked list of solutions that are applicable to the issue, the query including the metric and the another metric;
selecting, by the processor, another recommended solution from the another ranked list; and
transmitting, by the processor, the another recommended solution to the another client device.

7. The computer-implemented method of claim 5, further comprising:
performing, by the processor, another query on the predictive analysis engine to generate another ranked list of technicians available to service the problem;
selecting, by the processor, a technician from the another ranked list; and
scheduling, by the processor, the technician to the on-site visit.

8. A non-transitory computer readable storage medium storing one or more programs, the one or more programs comprising instructions for:
receiving, from a client device, an issue report configured to report a problem experienced with a sales item;
identifying a metric associated with the sales item that is missing in the issue report;
transmitting a measurement request to the client device to retrieve the metric;
receiving the metric from the client device;
performing a query on a predictive analysis engine to generate a ranked list of solutions that are applicable to the issue, the query including the metric;
selecting a recommended solution from the ranked list; and
transmitting the recommended solution to the client device.

9. The non-transitory computer readable storage medium of claim 8, wherein identifying the metric comprises:
identifying a plurality of metrics utilized by the predictive algorithm to generate the ranked list; and
determining that the metric is missing in the issue report.

10. The non-transitory computer readable storage medium of claim 8, wherein the measurement request includes at least one user instruction to retrieve the metric using the client device.

11. The non-transitory computer readable storage medium of claim 10, wherein the metric is measured using a sensor on the client device.

12. The non-transitory computer readable storage medium of claim 8, wherein the recommended solution is an on-site visit from a technician.

13. The non-transitory computer readable storage medium of claim 12, further comprising:
transmitting another measurement request to another client device, the another client device being operated by the technician;
receiving another metric from the another client device; and
performing another query on the predictive analysis engine to generate another ranked list of solutions that are applicable to the issue, the query including the metric and the another metric;
selecting another recommended solution from the another ranked list; and
transmitting the another recommended solution to the another client device.

14. The non-transitory computer readable storage medium of claim 12, further comprising:
performing another query on the predictive analysis engine to generate another ranked list of technicians available to service the problem;
selecting a technician from the another ranked list; and
scheduling the technician to the on-site visit.

15. A computer implemented system, comprising:
one or more computer processors; and
a non-transitory computer-readable storage medium comprising instructions, that when executed, control the one or more computer processors to be configured for:
receiving, from a client device, an issue report configured to report a problem experienced with a sales item;
identifying a metric associated with the sales item that is missing in the issue report;
transmitting a measurement request to the client device to retrieve the metric;
receiving the metric from the client device;
performing a query on a predictive analysis engine to generate a ranked list of solutions that are applicable to the issue, the query including the metric;
selecting a recommended solution from the ranked list; and
transmitting the recommended solution to the client device.

16. The computer implemented system of claim 15, wherein identifying the metric comprises:
identifying a plurality of metrics utilized by the predictive algorithm to generate the ranked list; and
determining that the metric is missing in the issue report.

17. The computer implemented system of claim 15, wherein the measurement request includes at least one user instruction to retrieve the metric using the client device.

18. The computer implemented system of claim 15, wherein the recommended solution is an on-site visit from a technician.

19. The computer implemented system of claim 18, further comprising:
transmitting another measurement request to another client device, the another client device being operated by the technician;
receiving another metric from the another client device; and
performing another query on the predictive analysis engine to generate another ranked list of solutions that are applicable to the issue, the query including the metric and the another metric;
selecting another recommended solution from the another ranked list; and
transmitting the another recommended solution to the another client device.

20. The computer implemented system of claim 18, further comprising:
performing, by the processor, another query on the predictive analysis engine to generate another ranked list of technicians available to service the problem;
selecting, by the processor, a technician from the another ranked list; and
scheduling, by the processor, the technician to the on-site visit.
